(19) United States
(12) Patent Application Publication
(10) Pub. No.: US 2013/0077690 A1
(43) Pub. Date: Mar. 28, 2013

(54) Firmware-Based Multi-Threaded Video Decoding

(71) Applicants: Jian Wei, San Diego, CA (US); Girish Jian, San Diego, CA (US); Junchen Du, San Diego, CA (US)

(72) Inventors: Jian Wei, San Diego, CA (US); Girish Jian, San Diego, CA (US); Junchen Du, San Diego, CA (US)

(73) Assignee: QUALCOMM Incorporated, San Diego, CA (US)

(21) Appl. No.: 13/241,322

(22) Filed: Sep. 23, 2011

(51) Int. Cl. H04N 7/26; H04N 7/32

(52) U.S. Cl. 375/240.16; 375/240.24; 375/E07.148; 375/E07.123

(57) ABSTRACT

Embodiments of the present disclosure provide electronic devices and methods for equipping a multi-threaded processor with firmware instructions to configure threads to perform dedicated functions to expedite decoding of video data. In a particular embodiment, an electronic device includes a multi-threaded processor and a memory. The memory includes firmware including instructions executable by the multi-threaded processor, without use of a dedicated hardware macroblock decoding module, to decode video data compliant with a VP6 format.

### I. FIELD

The present disclosure is generally related to apparatuses and methods for video decoding.

### II. DESCRIPTION OF RELATED ART

Internet streaming video is a popular application for users of both wired and wireless devices. To reduce bandwidth used by streaming video, video data is generally encoded to compress the video data. Encoding processes seek to compress the video data so as to provide satisfactory image quality without incurring undue decoding overhead at the user end. It is an objective of video encoding and decoding to find a balance between being able to generate high quality video from low bit rate data and low computational complexity.

A popular coder/decoder (CODEC) system for Internet streaming video is the Google-On2 VP6 (VP6) video CODEC. Providing high quality video at a relatively low bit rate results in the VP6 CODEC being computationally intensive. Decoding efficiency may be improved with dedicated decoding hardware, but inclusion of a dedicated video decoding processor in an end-user device increases the cost of the device. Further, it may not be practical to include dedicated decoding hardware in mobile devices, particularly because it may not be practical to incorporate newer codecs into existing hardware in the future. Without dedicated decoding hardware, mobile devices may lack sufficient processing power to decode VP6 video clips, particularly for high definition or “HD” video content.

### III. SUMMARY

A general-purpose, multi-threaded processor is associated with firmware including instructions to configure the multi-threaded processor as a specialized video decoding processor. Operating as configured by the firmware instructions, one thread of a processor is configured as a pre-processing thread that allocates macroblocks of video data, such as flash video data compliant with a VP6 format, among other threads configured to process the macroblocks and perform coefficient decoding. The pre-processing thread balances a workload between the processing threads, and the pre-processing thread may act as a processing thread for some macroblocks to further assist in workload balancing. One or more other threads may be configured to perform front-end processing to decode other video data included in received frames of video data or to perform post-processing to enhance the decoded video data. As a result, without allocating space or incurring cost to include a dedicated hardware processor, a digital signal processor or a general purpose processor that supports signal processing instructions can be configured to perform efficient video decoding.

Embodiments of the present disclosure provide electronic devices and methods for equipping a multi-threaded processor with firmware instructions to configure threads to perform functions to support decoding video data, such as VP6. One thread may be configured as a pre-processing thread to allocate macroblocks of video data among one or more processing threads configured to perform video decoding on the macroblocks. A task buffer may be used through which the pre-processing thread allocates macroblocks to particular processing threads without engaging an operating system. A particular thread may be configured as a front-end thread, for example, to decode a frame header and to perform a prediction mode or motion vector parsing. Still another thread may be configured as a post-processing thread to perform deblocking video format transformation, or other video enhancement functions.

In a particular embodiment, an electronic device includes a multi-threaded processor and a memory. The multi-threaded processor is configured to execute digital signal processing instructions. The memory includes firmware including instructions executable by the multi-threaded processor, without use of a dedicated hardware macroblock decoding module, to decode video data compliant with a VP6 format.

In another particular embodiment, an electronic device includes a processor including a plurality of threads and a memory that maintains firmware instructions executable by the processor to perform functions to process video data. The instructions in the firmware configure at least some of the plurality of threads to operate as a plurality of dedicated function threads. The dedicated function threads include one or more processing threads. Each of the processing threads is configured to perform video decoding on one or more macroblocks of video data. The dedicated function threads also include a pre-processing thread configured to receive a plurality of macroblocks and to allocate at least some of the plurality of macroblocks among the one or more processing threads for video decoding.

In another particular embodiment, a method includes receiving video data including a plurality of macroblocks at a processor. The processor includes a plurality of threads. At least some of the plurality of threads are configured according to instructions in firmware associated with the processor to perform dedicated functions. The method also includes configuring the plurality of threads to perform dedicated functions. Configuring the plurality of threads to perform dedicated functions includes configuring one or more of the plurality of threads as processing threads to perform video decoding on one or more macroblocks of the video data. Configuring the plurality of threads to perform dedicated functions also includes configuring one of the plurality of threads as a pre-processing thread to allocate the plurality the macroblocks for the video decoding.

### IV. BRIEF DESCRIPTION OF THE DRAWINGS

FIG. 1 is a block diagram of a particular illustrative embodiment of a system including a multi-threaded processor having threads configurable according to firmware-based instructions to perform dedicated functions for video decoding;

FIG. 2 is a block diagram of a particular illustrative embodiment of the multi-threaded processor of FIG. 1 configured according to firmware-based instructions to include threads for performing dedicated functions for video decoding on a frame of video data;

FIGS. 3-4 are diagrams of a particular illustrative embodiment of the multi-threaded processor of FIGS. 1-2 showing different threads dedicated as a front-end thread, a pre-processing thread, and a plurality of processing threads to perform dedicated functions in decoding video data;

FIG. 5 is a diagram of another particular illustrative embodiment of the multi-threaded processor of FIGS. 1-2 showing different threads dedicated as a pre-processing thread and a plurality of processing threads without using a dedicated front-end thread;

FIGS. 6 and 7 are block diagrams of a particular illustrative embodiment of a lockless task buffer used by the multi-threaded processor of FIGS. 1-5 to allocate macroblocks of video data to processing threads for video decoding;

FIG. 8 is a flow diagram of a particular illustrative embodiment of a method of configuring threads of the multi-threaded processor of FIGS. 1-5 to perform dedicated functions for video decoding; and

FIG. 9 is a block diagram of a particular illustrative embodiment of a wireless device including a multi-threaded processor having threads configurable according to firmware-based instructions to perform dedicated functions for video decoding.

### V. DETAILED DESCRIPTION

Embodiments of the present disclosure enable efficient video data decoding. Threads of a multi-threaded processor or multiple-threaded digital signal processor are configured to perform dedicated functions according to instructions in firmware of the processor. In a particular embodiment, a thread is configured as a front-end thread to decode parts of the video data, such as a frame header, a prediction mode, or motion vector data. Another thread is configured as a pre-processing thread to allocate macroblock data among multiple other threads configured to perform more intensive decoding, e.g., rendering decoded video from coding coefficients. The pre-processing thread also may be configured to perform video decoding of a macroblock when each of the plurality of processing threads is already performing decoding of another macroblock, thereby helping to prevent or reduce a backlog of macroblock decoding for the plurality processing threads. In a particular embodiment, the pre-processing thread determines to which of the plurality of processing threads to assign the macroblocks and then stores the macroblocks in slots in a lockless task buffer. Each slot in the lockless task buffer is dedicated to a particular one of the plurality of processing threads. Each of the plurality of processing threads may retrieve assigned macroblocks from an assigned dedicated slot in the lockless task buffer as soon as the processing thread completes a previous task. Each of the processing threads can access the lockless task buffer directly and asynchronously without waiting for a lock on the task buffer to be released by another processing thread or having to participate in a contention avoidance process managed by an operating system or other software. In another embodiment, no thread is configured as a front end thread, resulting in additional decoding for the pre-processing thread but freeing another thread to be used as a processing thread.

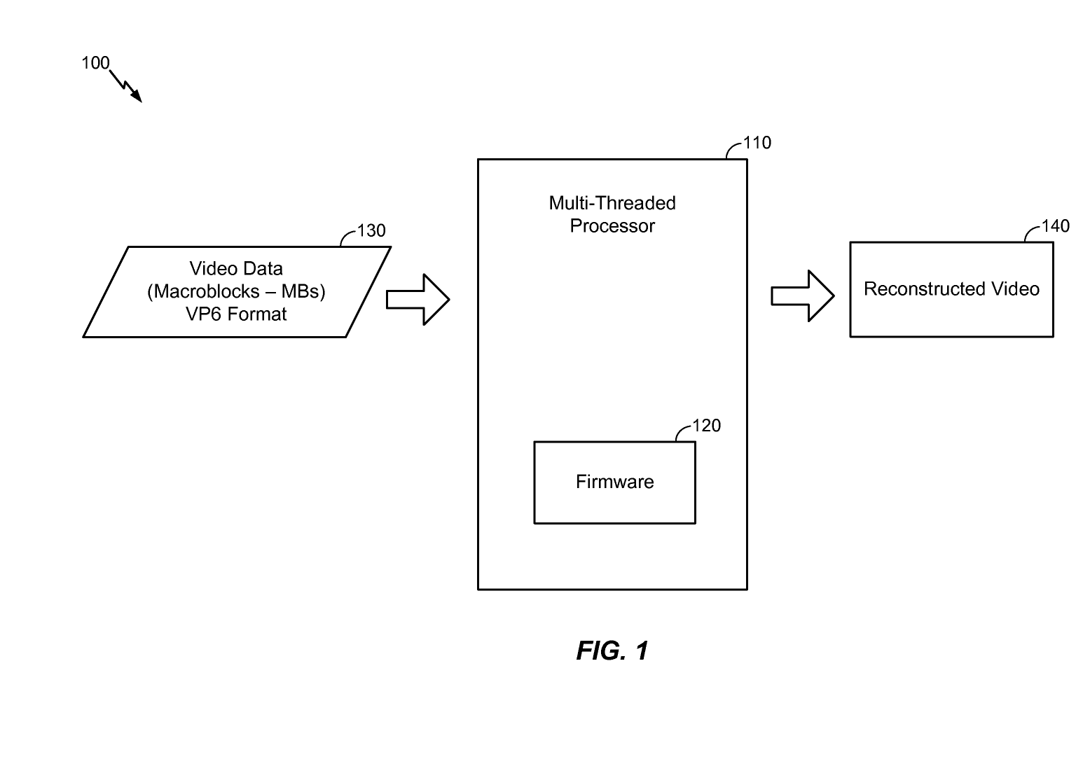

FIG. 1 is a block diagram of a particular illustrative embodiment of a system 100 including a multi-threaded processor 110 having threads configurable according to firmware-based instructions to perform dedicated functions for video decoding. The multi-threaded processor 110 incorporates or is operably coupled to firmware 120 including instructions for configuring the threads of the multi-threaded processor 110. In a particular embodiment, the multi-threaded processor 110 is a general purpose processor and the multi-threaded processor 110 is not dedicated for video decoding and does not include dedicated hardware for video decoding. In another particular embodiment, the multi-threaded processor 110 includes a digital signal processor (DSP) device that does not included dedicated hardware for VP6 decoding or for decoding other video data formats.

After threads of the multi-threaded processor 110 are configured to perform dedicated functions for video decoding, the threads of the multi-threaded processor 110 perform those functions to decode video data 130, such as macroblocks of VP6 format data, MPEG-4, H.264, or other video data. In a particular embodiment, the video data is flash video data that is encoded in a VP6 format and that is streamed via the Internet. Configuration of the threads of the multi-threaded processor 110 to perform dedicated functions may enable efficient decoding of the video data 130. The multi-threaded processor 110 decodes the video data 130 to generate decoded video data 140. In a particular embodiment, the video data 130 is decoded at a speed of 30 frames per second or more and at a resolution of up to 1280 by 720.

A general-purpose multi-threaded processor configured according to firmware-based instructions may afford a number of advantages for video decoding. First, a signal processor configured by firmware-based instructions to perform video decoding may provide greater image processing throughput than a general purpose processor performing software-based decoding. Second, including a signal processor that is configurable by firmware-based instructions to perform video decoding provides at least some of the advantages of dedicated decoding hardware without adding the cost or consuming the space that a dedicated video decoder may require. These advantages may be particularly beneficial in a mobile device.

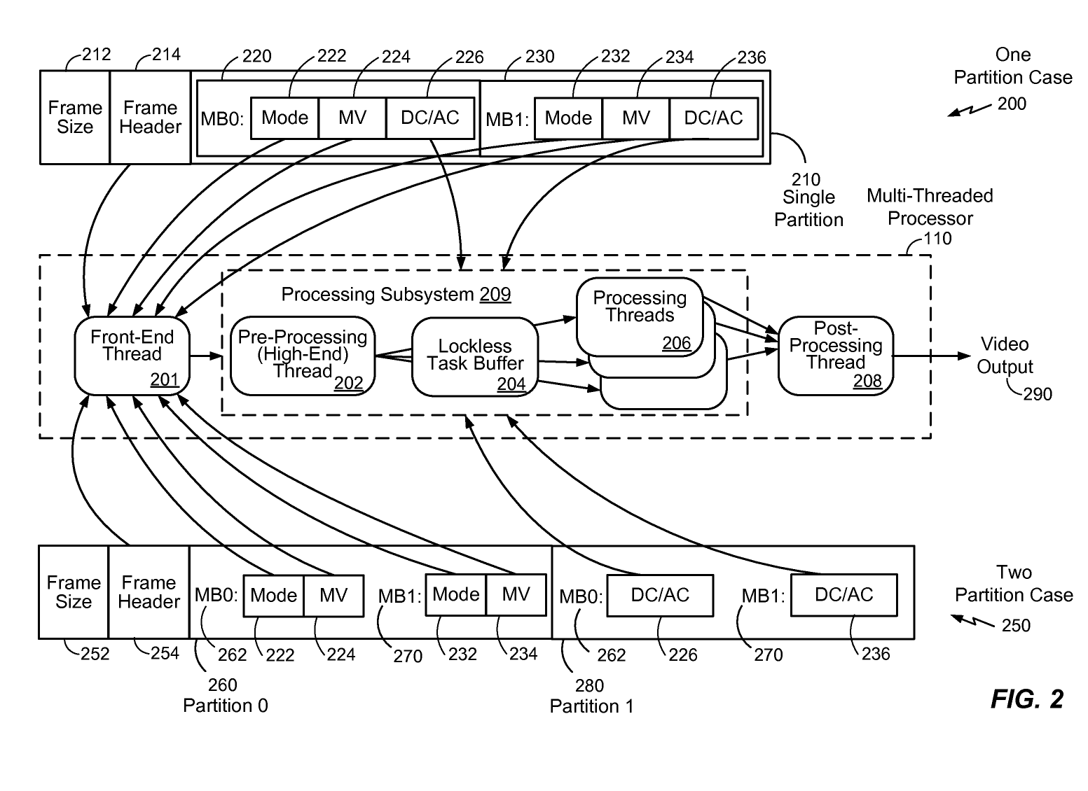

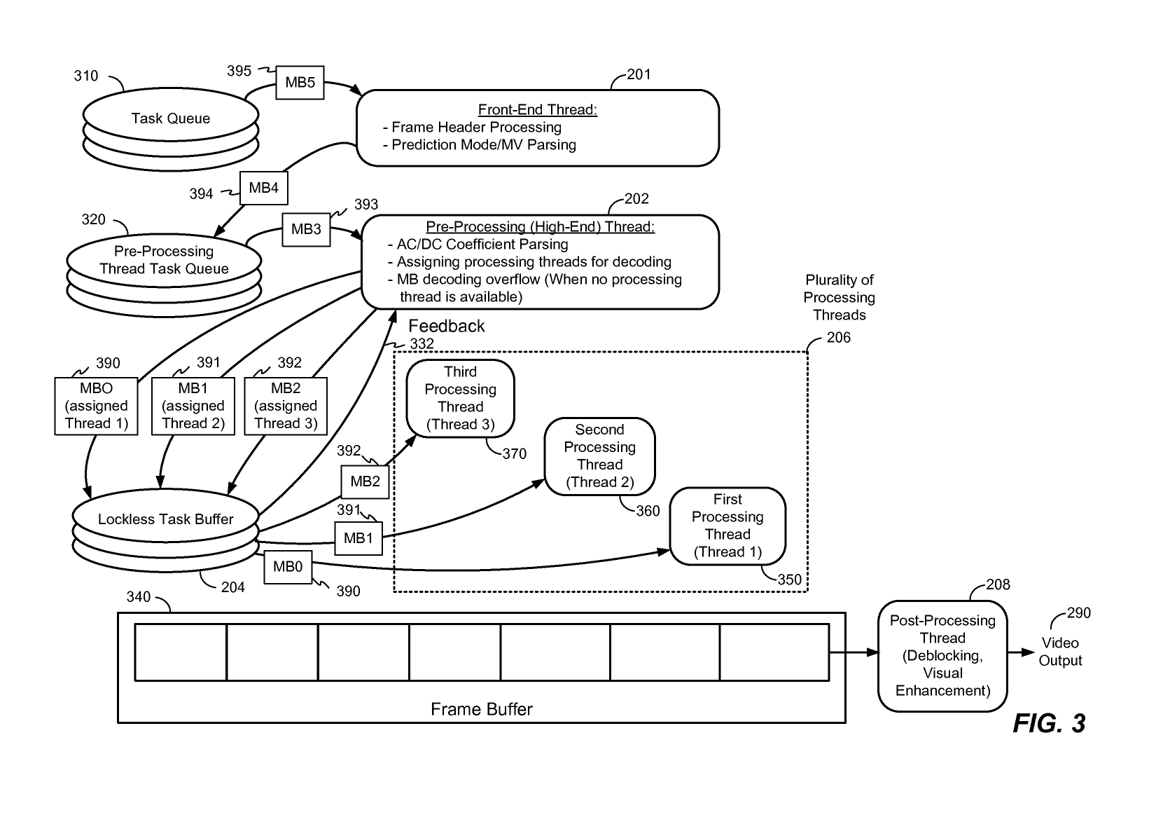

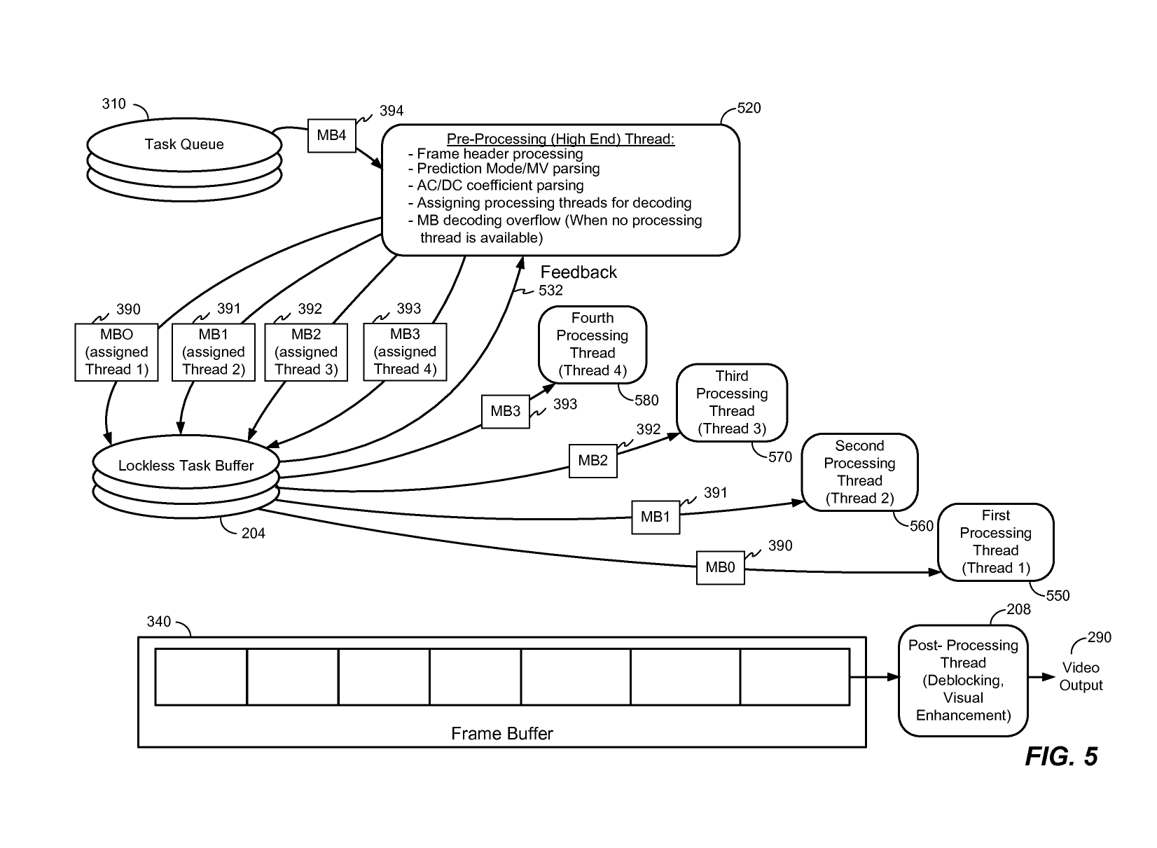

FIG. 2 is a block diagram of a particular illustrative embodiment of the multi-threaded processor 110 of FIG. 1 configured according to firmware-based instructions to include threads for performing dedicated functions for video decoding on a frame of video data 250. In one particular embodiment, threads of the multi-threaded processor 110 are configured to function as a front-end thread 201, a pre-processing or high-end thread 202, a plurality of processing threads 206, and a post-processing or back-end thread 208. One or more of the processor threads may be configured as processing threads. For purposes of description, a plurality of threads is configured as a plurality of processing threads 206. In particular illustrative embodiments as further described with reference to FIGS. 3-6, the pre-processing thread 202 assigns decoding of video data from macroblocks to individual processing threads of the plurality of processing threads 206 and stores the macroblock data in a lockless task buffer 204 from which each of the plurality of processing threads 206 may retrieve the assigned macroblock data. However, the configuration of the threads 201, 202, 206, and 208 of the multi-threaded processor 110 as illustrated in FIG. 2 are only one possible embodiment. In other embodiments, the multi-threaded processor 110 may be configured to perform video decoding without the front-end thread 201, as described further with reference to FIG. 5.

Macroblock data in VP6 format may be transmitted in one or more partitions. In the example of FIG. 2, data stored in each of the macroblocks MB0 (220 in the one partition case 200 and 262 in the two partition case) and MB1 (230 in the one partition case 200 and 270 in the two partition case 250) are the same; the difference is that, in the one partition case 200, a single partition 210 includes all data for a plurality of macroblocks. For example, for the macroblock MB0 220, the single partition 210 includes prediction mode (“mode”) data 222, motion vector (“MV”) data 224, and direct current and alternating current (“DC/AC”) coefficients 226 for video decoding. For the macroblock MB0 230, the single partition 210 also includes the mode data 232, MV data 234, and DC/AC coefficients 236.

By contrast, in the two partition case 250, two partitions such as Partition 0 260 and Partition 1 280 may be employed to carry different portions of data for each of a plurality of macroblocks. For example, the mode data 222 and 232 for macroblocks MB0 262 and MB1 270 (in the two partition case 250) are presented in a first partition, Partition 0 260, while a second partition, Partition 1 280, includes the DC/AC coefficients 226 and 236 for the macroblocks MB0 262 and MB1 270 (in the two partition case 250). The one partition case 200 may be employed for some advanced profile video clips. In the one partition case 200, the single partition 210 is Bool-encoded. The two partition case 250 may be employed for some advanced profile video clips (e.g., clips with high bitrate, high definition content) and simple profile cases. In the two partition case 250, the first partition, e.g., Partition 0 260, is Bool-encoded while the second partition, e.g., Partition 1 280, is either Bool-encoded or Huffman-encoded.

Regardless of whether the macroblocks are transmitted using the one partition case 200 or the two partition case 250, portions of the macroblock data are distributed to threads within the multi-threaded processor 110 in the same way. In a particular illustrative embodiment in which one of the threads is configured at the front-end thread 201, frame header data 214 (from the one partition case 200) or 254 (from the two partition case 250) is assigned to the front-end thread 201. Mode data 222 and 232 and MV data 224 and 234 is assigned to the front-end thread 201 for decoding.

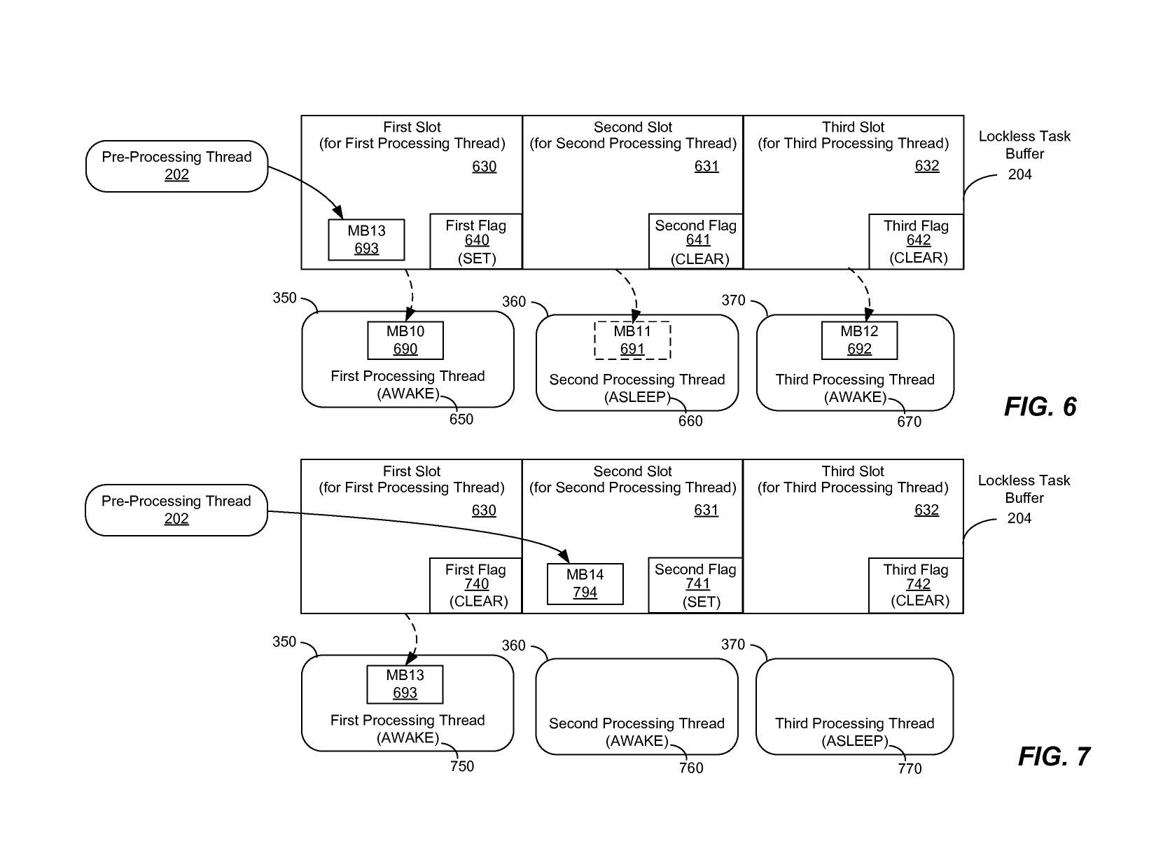

Processing of DC/AC coefficient data 226 and 236, which is a more intensive aspect of the video decoding, is assigned to the plurality of processing threads 206 by the pre-processing thread 202. More specifically, the macroblock data including the DC/AC coefficient data 226 and 236 is assigned to the pre-processing thread 202 which assigns data for each of the macroblocks to one of the plurality of processing threads 206 via the lockless task buffer 204. The macroblock data is retrieved from the lockless task buffer 204 by each of the plurality of processing threads 206 when each of the plurality of processing threads 206 is ready to accept a next macroblock, as further described with reference to FIGS. 6 and 7. Accordingly, the DC/AC coefficient data 226 and 236 is shown in FIG. 2 as being assigned to a processing subsystem 209 that includes the pre-processing thread 202, the lockless task buffer 204, and the plurality of processing threads 206.

In a particular embodiment, the pre-processing thread 202 may be configured to perform functions in addition to assigning macroblocks among the plurality of processing threads 206. For example, the pre-processing thread 202 also may parse the DC/AC coefficients 226 and 236 to gauge relative processing complexity of the macroblocks. In addition, to further relieve bottlenecks and distribute the workload, when none of the plurality of processing threads 206 is available to decode a particular macroblock, the pre-processing thread 202 itself may decode the particular macroblock.

A post-processing thread 240 receives the decoded macroblocks from the plurality of processing threads and may perform functions such as deblocking, video format transformation and motion compensation on the decoded video data to generate a video output 290 to a display device (not shown in FIG. 2).

According to the particular illustrative embodiment of FIG. 2, configuring the multi-threaded processor 110 to perform particular, dedicated video decoding functions may dedicate processing resources to performing at least partial workload balancing. When an available thread is configured as the pre-processing thread 202, the pre-processing thread 202 may monitor the plurality of processing threads 206 (or monitor the lockless task buffer 204 from which the plurality of processing threads 206 receive macroblocks for decoding) to determine which of the plurality of processing threads 206 are engaged in decoding video data or are losing cycles waiting for assignment of a next processing task. The time and resources involved in decoding macroblock data based on DC/AC coefficients may vary significantly depending on the homogeneity or contrast within each of the macroblocks. Thus, the pre-processing thread 202 can assign macroblocks to those processing threads of the plurality of processing threads 206 that are ready to accept another macroblock for decoding. Correspondingly, the pre-processing thread 202 can avoid creating decoding backlogs by assigning macroblocks to processing threads of the plurality of processing threads 206 that are not ready to receive another macroblock for decoding. Such a configuration may reduce bottlenecks that may result if the macroblocks were evenly distributed among the processing threads and in which one or more of the plurality of processing threads were idle while one or more others of the plurality of processing threads have amassed a backlog of macroblock data while decoding more complex macroblocks.

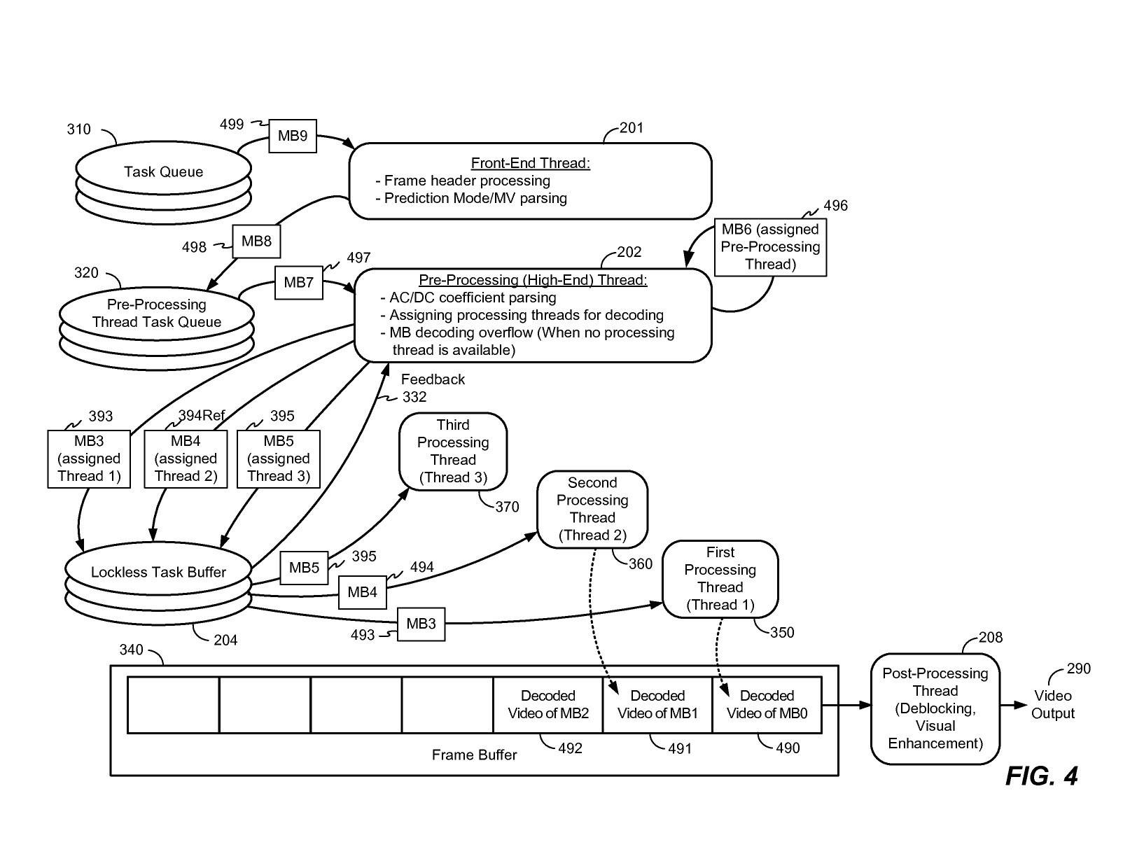

In addition to allocating the macroblocks among the plurality of processing threads 206, the pre-processing thread 202 also may perform other functions. For example, the pre-processing thread may be used to parse the DC/AC coefficients 226 and 236 (in the single partition case) or to decode macroblocks. The pre-processing thread 202, like each of the plurality of processing threads 206, may be configured to perform macroblock decoding. As further described with reference to FIG. 4, the pre-processing thread 202 may assign a macroblocks to itself for decoding when each of the plurality of processing threads 206 already has one or more macroblocks queued for decoding.

Employing the lockless task buffer 204 to hold the macroblocks for the plurality of processing threads 206 also helps to improve decoding efficiency. Each of the plurality of processing threads 206 can retrieve macroblock data for decoding without waiting for a lock to be lifted, without waiting for operating system intervention, and without other delays that may result when the plurality of processing threads 206 do not have free access to a task buffer storing the macroblocks. Operation of the pre-processing thread 202 is described further with reference to FIGS. 3-5, and operation of the lockless task buffer 204 is described further with reference to FIGS. 6 and 7.

FIGS. 3 and 4 are diagrams illustrating operation of a particular illustrative embodiment of the multi-threaded processor 110 of FIGS. 1 and 2. Specifically, FIGS. 3 and 4 show different threads of the plurality of processing threads 206 performing dedicated functions in decoding video data. FIG. 3 shows a total of six processor threads being configured to perform different, dedicated functions, including configuring one of the plurality of threads as a front-end thread 201. The threads also include a pre-processing thread 202, a plurality of processing threads 206, and a post processing thread 240. The threads engage a task queue 310, a pre-processing thread task queue 320, and the lockless task buffer 204 which, as explained below, provides separate task queues for each of the plurality of processing threads 206. Once macroblocks have been decoded by the plurality of processing threads 206, resulting video data is stored in a frame buffer 340. The post-processing thread 240 then receives the decoded video data from the frame buffer 340 to produce a video output 290.

The dedicated threads operate to decode macroblocks of video data, including macroblock 0 (MB0) 390 through MB 5 395. FIG. 3 shows how the first macroblocks to be processed, e.g., macroblocks MB0 390, MB1 391, and MB2 392, have been pre-processed and passed to processing threads 350, 360, and 370 (of the plurality of processing threads 206) for video decoding. At the same time, FIG. 3 shows, after macroblocks MB0 390, MB1 391, and MB2 392 have been pulled from a task queue 310 and preprocessed, how additional macroblocks—e.g., macroblocks MB3 393, MB4 394, and MB5 395, are pre-processed to subsequently be passed to the plurality of processing threads 206 for video decoding.

Initially, each of the macroblocks, from macroblock MB0 390 through MB5 395 is stored in the task queue 310. Each of the macroblocks MB0 390 and MB5 395 is sequentially retrieved from the task queue 310 by the front-end thread 201, where the front-end thread 201 performs processing of frame header data, mode data, and motion vector data. The resulting macroblocks are then stored in a pre-processing thread task queue 320, The processor thread configured as the pre-processing (or “high-end”) thread 202 then retrieves each of the macroblocks from the pre-processing thread task queue 320. The pre-processing thread 202 assigns the macroblocks to one of the plurality of processing threads 206 and stores the macroblocks in a slot dedicated to the assigned processing thread in the lockless task buffer 204.

As further described below with reference to FIGS. 6 and 7, the lockless task buffer 204 maintains at least one dedicated slot for each of the plurality of processing threads 206. When a slot dedicated to a particular thread of the plurality of processing threads 206 is empty or free, the particular thread may be idle or still be processing a previously-assigned macroblock. When a slot is empty, the pre-processing thread 202 may put another macroblock in the slot to assign the macroblock to the particular thread so that the particular thread will not be idle at present or when the particular thread finishes with a previously assigned macroblock currently being processed. At the same time, if a slot for each of one or more of the plurality of processing threads 206 stores a previously-assigned macroblock, the pre-processing thread 202 can assign the macroblock to another of the plurality of processing threads 206 to avoid creating a bottleneck at one of the plurality of processing threads 206. A feedback link 332 may be used by the pre-processing thread to monitor which of the plurality of processing threads 206 have or do not have empty slots in the lockless task buffer 204.

Because one or more dedicated slots in the lockless task buffer 204 is associated with each of the plurality of processing threads 206, each of the plurality of processing threads 206 can access the lockless task buffer 204 to retrieve macroblocks without the task buffer having to be locked and without having to go through an operating system or other contention control system. Being able to directly and asynchronously access the lockless task buffer may avoid delays that may result from waiting for locks to be lifted or waiting for other contention control systems to provide access to the buffer.

In the example of FIG. 3, macroblock MB0 390 is assigned to a first processing thread 350 and, thus, is stored in a slot in the lockless task buffer 204. Similarly, macroblock MB1 is assigned to a second processing thread 360 and macroblock MB2 is assigned to a third processing thread 370. The first processing thread 350, when ready to accept a task, retrieves the macroblock MB0 from a slot associated with the first processing thread 350 in the lockless task buffer 204. The second processing thread 360 and the third processing thread 370 similarly retrieve the macroblocks MB1 391 and MB2 392, respectively. The processing threads 350, 360, and 370 then process the respective macroblock data to decode the video data from the DC and AC coefficients (226 and 236 in FIG. 2) associated with each of the macroblocks.

FIG. 4 shows a subsequent state of the processing threads and the video data they process. Following the processing of the macroblocks 390, 391, and 392 (FIG. 3), FIG. 4 shows that the first processing thread 350 is finishing the decoding of macroblock MB0 390 (FIG. 3) and stores decoded video of macroblock MB0 490 in the frame buffer 340. Similarly, the second processing thread 360 completes decoding macroblock MB1 391 (FIG. 3) and stores decoded video of macroblock MB1 491 in the frame buffer 340. The third processing thread 370 completes decoding of macroblock MB2 392 (FIG. 3) and stores decoded video of macroblock MB2 492 in the frame buffer 340. The post-processing thread 208 then retrieves the decoded video 490, 491, and 492 and performs deblocking, visual enhancement, or other post-processing to generate the video output 290.

While the processing threads 350, 360, and 370 process the macroblocks 390, 391, and 392, the front-end thread 201 retrieves additional macroblocks such as macroblocks MB6 496, MB7 497, MB8 498, and MB9 499 from the task queue 310 and processes frame header data, prediction mode data, and motion vector data. The front-end thread 201 stores the macroblocks MB6 496, MB7 497, MB8 498, and MB9 499 in the pre-processing thread task queue 320. The pre-processing thread 202 retrieves macroblocks, such as the macroblock MB7 497, from the pre-processing task queue 320 for coefficient parsing and assignment to a processing thread. The macroblocks MB3 393, MB4 394, and MB5 395 have been retrieved from the pre-processing thread task queue 320 by the pre-processing thread 202 and slotted in the lockless task buffer 204 to assign the macroblocks MB3 393, MB4 394, and MB5 395 to the first processing thread 350, the second processing thread 360, and the third processing thread 370, respectively.

In a particular illustrative embodiment, to facilitate workload balancing and to enhance throughput, the pre-processing thread 202 may assign macroblocks to itself and may act as an additional processing thread to decode one or more macroblocks. For example, before the processing threads 350, 360, and 370 retrieve the macroblocks MB3 393, MB4 394, and MB5 395, respectively, from the lockless task buffer 204, the feedback link 332 indicates to the pre-processing thread 202 that the slots in the lockless task buffer 204 are filled. With the slots in the lockless task buffer 204 filled, if the pre-processing thread 202 assigns a next macroblock, macroblock MB6 496, to one of the already filled slots, a video decoding backlog would result. Instead, the pre-processing thread 202 assigns decoding of the macroblock MB6 496 to itself. In other words, instead of continuing to assign macroblocks to the processing threads 350, 360, and 370 that already have a next macroblock queued for processing, the pre-processing thread helps to avoid a potential backlog by devoting cycles to decoding the macroblock MB6 496. When the pre-processing thread 202 completes decoding of the macroblock MB6 496, the pre-processing thread 202 stores the decoded video in the frame buffer 340 and then retrieves a next macroblock, such as macroblock MB7 497, for assignment to one of the processing threads 350, 360, and 370 (or to itself if the slots in the lockless task buffer 204 remain filled).

FIG. 5 illustrates another particular embodiment of a system in which processing threads are configured to performing dedicated video processing functions. The system of FIG. 5, like the system of FIGS. 3 and 4, includes a total of six processor threads. However, instead of assigning one of the processor threads as a front-end thread (such as the front-end thread 201 of FIGS. 3 and 4), functions of the front-end thread are assigned to a processor thread configured as the pre-processing thread 520. As a result, in addition to functions performed by the pre-processing thread 202 in parsing coefficients, assigning macroblocks, and in performing macroblock decoding when the lockless task buffer 204 is filled, the pre-processing thread 202 also performs tasks such as frame header processing, prediction mode processing, and motion vector processing that were performed by the front-end thread 201 of FIGS. 3 and 4. Instead of allocating one of the processor threads as a front-end thread, it may be desirable to assign an additional processor thread as one of the processing threads. Thus, in contrast to the system of FIGS. 3 and 4, the system of FIG. 5 has four threads dedicated to full-time video decoding, including a first processing thread 550, a second processing thread 560, a third processing thread 570, and a fourth processing thread 580. When the complexity of decoding video from the DC and AC coefficients is high, the system of FIG. 5 may be more efficient than that of the system of FIGS. 3 and 4 by devoting an additional, fourth processor thread to what may be a more intensive task than tasks performed by the front-end thread 201.

FIGS. 6 and 7 are block diagrams of a particular illustrative embodiment of the lockless task buffer 204 used by the multi-threaded processor 110 of FIGS. 1-5 to allocate macroblocks of video data to processing threads such as processing threads 350, 360, and 370 for video decoding. The embodiment of FIGS. 6 and 7 show one slot 630, 631, and 632 being dedicated to each of the three processing threads 350, 360, and 370, respectively. However, although not shown in FIG. 6 or 7, the lockless task buffer 204 may alternatively include two or more slots dedicated to each of the processing threads 350, 360, and 370.

When one of the processing threads 350, 360, and 370 is available to receive and process a macroblock, the respective processing thread 350, 360, and 370 retrieves a macroblock from the respective slot 630, 631, and 632 associated with each of the processing threads 350, 360, and 370. Allocation of the dedicated slots 630, 631, and 632 to each of the respective processing threads 350, 360, and 370, respectively, enables each of the processing threads to retrieve an assigned macroblock from the lockless task buffer 204 whenever each of the processing threads completes decoding of a previously assigned macroblock and is ready to decode another macroblock. Because the slots 630, 631, and 632 are dedicated to individual processing threads 350, 360, and 370, respectively, the processing threads only retrieve macroblocks from their own dedicated slots, and do not contend for macroblocks assigned to other slots. Thus, the lockless task buffer 204 may be accessed independently and asynchronously by the processing threads 350, 360, and 370 without locking or other contention control mechanisms. The lockless task buffer 204 may thus avoid delays in supplying macroblocks to processing threads.

Each of the slots 630, 631, and 632 is associated with a flag 640, 641, and 642, respectively, to signal when each of the slots 630, 631, and 632 stores a macroblock for a respective processing thread 350, 360, or 370. In a particular illustrative embodiment, the flags 640, 641, and 642, are set when a macroblock is stored in the respective slot 630, 631, and 632. The flags 640, 641, and 642 are cleared when no macroblock is stored in the respective slot 630, 631, and 632, signaling to the respective processing thread 350, 360, and 370 that there are no macroblock waiting to be decoded. When no macroblock is stored in the dedicated slot 640, 641, or 642 for one of the respective processing threads 350, 360, or 370, the respective processing thread 350, 360, or 370 may assume a standby or sleep state.

In the example of FIG. 6, each of the processing threads 350, 360, and 370 has retrieved a macroblock from the respective slots 630, 631, and 632 of the lockless task buffer 204 for decoding. The first processing thread 350 decodes macroblock MB10 690, and a status 650 of the first processing thread is “AWAKE.” The second processing thread 360 has just completed decoding macroblock MB11 691, as signified by the macroblock MB11 691 appearing in dashed lines. Without another macroblock in the slot 631 for the second processing thread 360, a status 660 of the second processing thread is “ASLEEP.” The third processing thread 370 decodes macroblock MB12 692, and a status 670 of the third processing thread is “AWAKE.” The pre-processing thread 202 has assigned another macroblock, macroblock MB13 693, to the first slot 630 for the first processing thread 350. Because the first slot 630 stores the macroblock MB1 693, the first flag 640 of the first slot is placed in a “SET” state. In contrast, because the second slot 631 and the third slot 632 do not store macroblocks for decoding, the second flag 641 and the third flag 642 are placed in a “CLEAR” state.

In the example of FIG. 7, the first processing thread has retrieved the macroblock MB13 693 from the first slot 630 and continues to decode the macroblock MB13 693, and a status 750 for the first processing thread 350 is “AWAKE.” The second processing thread 360 previously was in a sleep state, but the pre-processing thread 202 assigning a new macroblock, macroblock MB14 794, to the second processing thread 360 via the second slot 631 and causes the second processing thread 360 to “wake up” and assume a status 760 of “AWAKE.” The third processing thread 370 is idle after having completed decoding of the macroblock MB12 692 (FIG. 6). A status 770 for the third processing thread 370 is “ASLEEP,” thereby reducing power consumption and reducing heat generation when the third processing thread 370 is not in use. The pre-processing thread 202 has assigned one additional macroblock, macroblock MB14 794, for decoding.

The pre-processing thread 202 assigned the macroblock MB14 794 to the second slot 631 because the second flag 641 (FIG. 6) previously indicated that the second slot 631 was empty and available to receive another macroblock. Because the macroblock MB14 794 is assigned to the second slot 631, a second flag 741 is placed in the “SET” state. In contrast, because the first slot 630 and the third slot 632 do not store macroblocks for decoding, respective first and third flags 740 and 742 are placed in the “CLEAR” state.

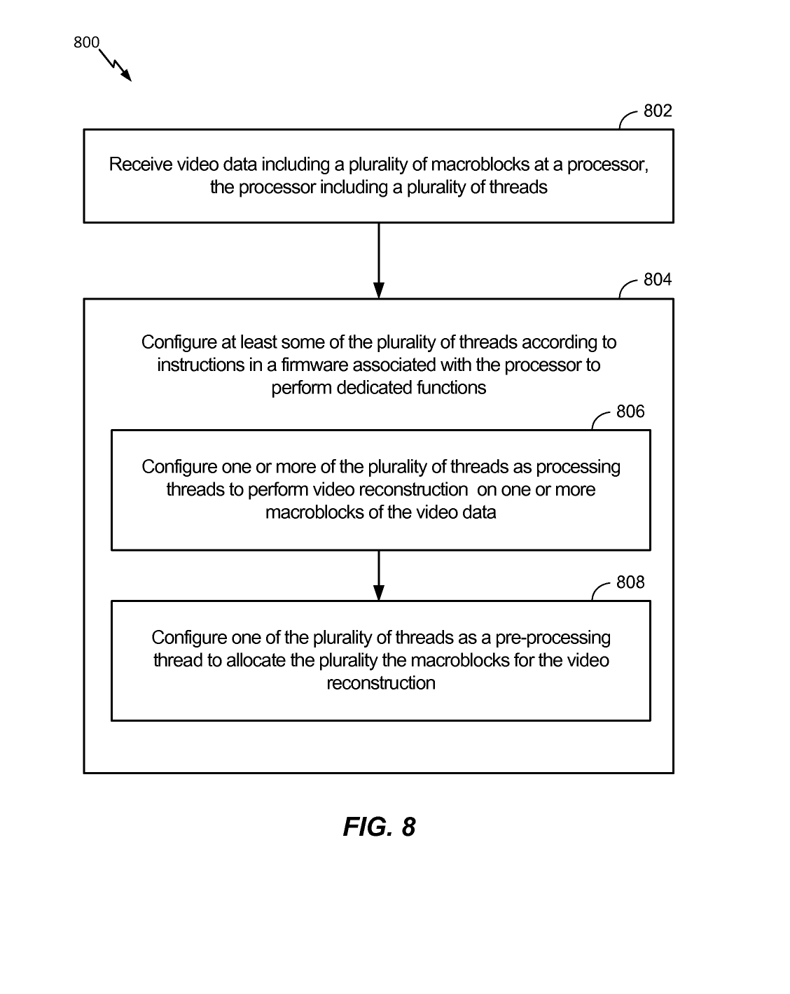

FIG. 8 is a flow diagram of a particular illustrative embodiment of a method of configuring threads of the multi-threaded processor of FIGS. 1-5 to perform dedicated functions for video decoding. Video data, including a plurality of macroblocks, is received at a multi-threaded processor 110 (FIGS. 1-2) or other processor including a plurality of threads, at 802. At least some of the plurality of threads of the processor 110 are configured to perform dedicated functions pursuant to instructions in a firmware associated with the processor, at 804. Configuring the plurality of threads to perform the dedicated functions may include configuring one or more of the plurality of threads as processing threads 206 (FIG. 2) to perform video decoding on one or more macroblocks of the video data, at 806. The processing threads 230 may be configured to decode DC and AC coefficients of video data, as previously described. Configuring the plurality of threads may also include configuring one of the other threads of the plurality of threads as a pre-processing thread 202 (FIGS. 2-7) to allocate the plurality of macroblocks for the video decoding, at 808. As previously described with reference to FIG. 2, macroblocks may be allocated to the processing threads 202. One or more of the macroblocks may also be allocated to the pre-processing thread 202 for video decoding (e.g., to at least partially balance processing thread workloads) as described with reference to FIG. 4.

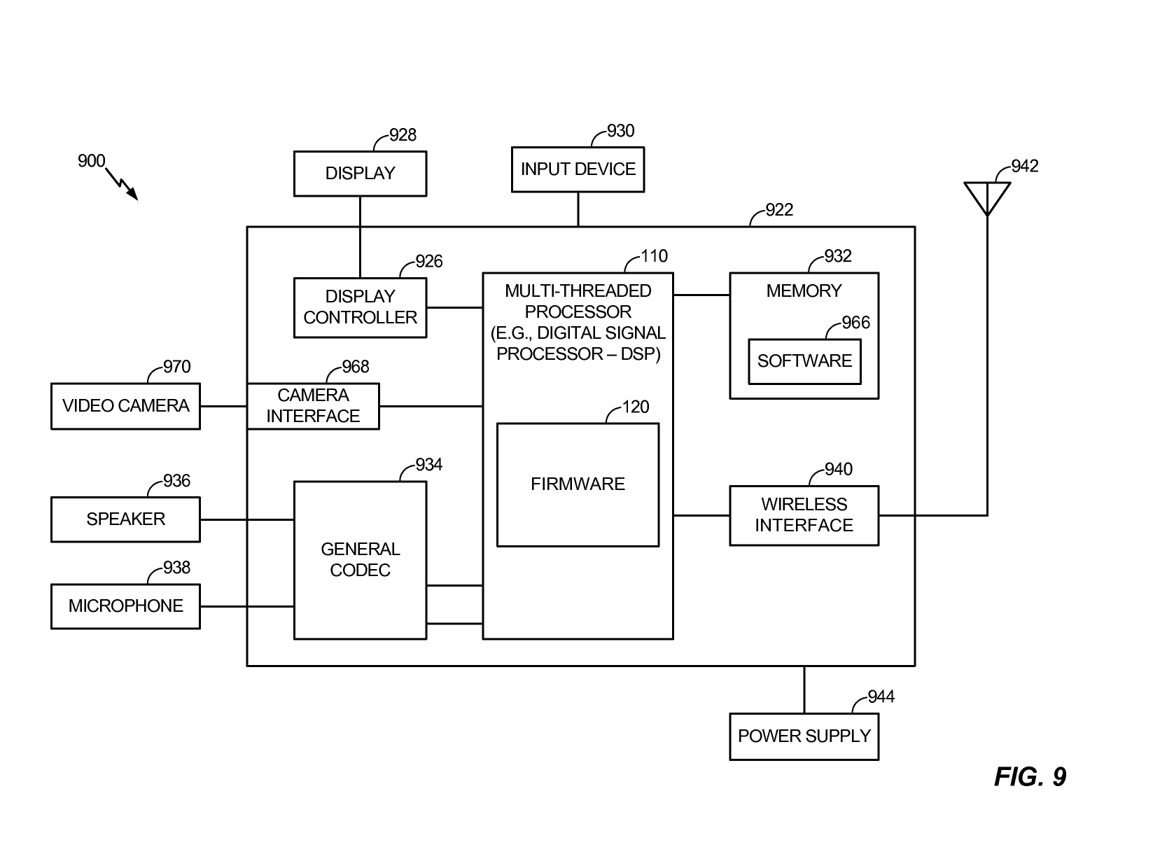

FIG. 9 is a block diagram of a particular illustrative embodiment of a wireless device 900 including a multi-threaded processor 110 having threads configurable according to firmware-based instructions to perform dedicated functions for video decoding.

The wireless device 900 may be implemented in a portable electronic device and includes the multi-threaded processor 110, which may include a digital signal processor (DSP). The multi-threaded 110 processor is associated with a memory such as a firmware 120 that includes instructions enabling the multi-threaded processor 110 to configure threads to perform different dedicated functions as previously described with reference to FIGS. 1-8. The firmware 120 may include instructions to configure the multi-threaded processor 110 to operate as a specialized video data decoding system to decode, for example, VP6 format video data. The multi-threaded processor 110 is coupled to a computer readable medium, such as a memory 932, storing computer readable instructions, such as software 966, that control applications or other functions supported by the wireless device 900.

A camera interface 968 is coupled to the multi-threaded processor 110 and also coupled to a camera, such as a video camera 970. A display controller 926 is coupled to the multi-threaded processor 110 and to a display device 928. A general coder/decoder (general CODEC) 934 can also be coupled to the processor 110. A speaker 936 and a microphone 938 can be coupled to the general CODEC 934 to encode or decode audio data or to encode and decode other types of video data. A wireless interface 940 can be coupled to the processor 110 and to a wireless antenna 942. Via the wireless interface 940, the wireless device 900 may receive streamed or downloadable VP6 format data to be decoded by the multi-threaded processor 110 configured according to the instructions stored in the firmware 120 for configuring threads of the multi-threaded processor 110 to perform VP6 decoding.

In a particular embodiment, the multi-threaded processor 110, the display controller 926, the memory 932, the CODEC 934, the wireless interface 940, and the camera interface 968 are included in a system-in-package or system-on-chip device 922. In a particular embodiment, an input device 930 and a power supply 944 are coupled to the system-on-chip device 922. Moreover, in a particular embodiment, as illustrated in FIG. 5, the display device 928, the input device 930, the speaker 936, the microphone 938, the wireless antenna 942, the video camera 970, and the power supply 944 are external to the system-on-chip device 922. However, each of the display device 928, the input device 930, the speaker 936, the microphone 938, the wireless antenna 942, the video camera 970, and the power supply 944 can be coupled to a component of the system-on-chip device 922, such as an interface or a controller.

Those of skill would further appreciate that the various illustrative logical blocks, configurations, modules, circuits, and method steps described in connection with the embodiments disclosed herein may be implemented as electronic hardware, computer software executed by a processing unit, or combinations of both. Various illustrative components, blocks, configurations, modules, circuits, and steps have been described above generally in terms of their functionality. Whether such functionality is implemented as hardware or executable processing instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), a magnetoresistive random access memory (MRAM), a spin-torque-transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An electronic device comprising:
a multi-threaded processor configured to execute digital signal processor instructions; and
a memory that includes firmware including instructions executable by the multi-threaded processor without use of a dedicated hardware macroblock decoding module, to decode flash video data.

2. The electronic device of claim 1, wherein the firmware includes instructions that configure each of a plurality of threads to perform a dedicated function, the plurality of threads including:
one or more processing threads, each of the one or more processing threads being configured to perform video decoding on a macroblock of the flash video data; and
a pre-processing thread configured to receive a plurality of macroblocks of the flash video data and to allocate at least some of the plurality of macroblocks among the one or more processing threads.

3. The electronic device of claim 2, wherein the plurality of threads includes a back-end thread, wherein the back-end thread performs at least one of deblocking and video format transformation on the flash video data.

4. The electronic device of claim 2, further comprising an interleaved task buffer having a plurality of slots, wherein one or more of the plurality of slots is associated with each of the one or more processing threads, wherein:
the pre-processing thread is configured to allocate a particular macroblock of the plurality of macroblocks to a particular processing thread of the one or more processing threads by allocating the particular macroblock to a particular slot of the plurality of slots associated with the particular processing thread; and
the particular processing thread is configured to retrieve the particular macroblock from the particular slot.

5. The electronic device of claim 4, wherein the interleaved task buffer is configured to include a task flag for each of the slots, wherein:
the task flag for the particular slot is set by the pre-processing thread after allocating the particular macroblock to the particular slot;
the task flag for the particular slot is cleared by the particular thread associated with the particular slot in response to the particular thread retrieving the particular macroblock from the particular slot, wherein clearing the task flag is configured to signal the pre-processing thread that the particular thread is available for allocation of another of the plurality of macroblocks.

6. The electronic device of claim 5, wherein the particular thread is configured such that:
upon the particular thread completing the video decoding of the particular macroblock and detecting that the task flag is cleared for each of the one or more of the plurality of slots associated with the particular processing thread, the particular processing thread enters a sleep state; and
upon the particular thread having previously entered the sleep state, awakening the particular thread with a wake-up signal upon at least one of the slots being populated by the pre-processing thread associated with the particular thread.

7. The electronic device of claim 4, wherein the interleaved task buffer is configured to enable the pre-processing thread to allocate the particular macroblock to the particular slot in the interleaved task buffer and to enable the particular processing thread to retrieve the particular macroblock from the particular slot of the interleaved task buffer without engaging an operating system.

8. The electronic device of claim 4, wherein the interleaved task buffer includes a lockless interleaved buffer, and wherein the particular thread is configured to access the lockless interleaved buffer irrespective of others of the one or more processing threads accessing the lockless interleaved buffer at a same time.

9. The electronic device of claim 2, wherein the pre-processing thread is configured to at least partially balance a processing load of the one or more processing threads.

10. The electronic device of claim 9, wherein the pre-processing thread is configured to selectively allocate at least some of the plurality of macroblocks based on which of the one or more processing threads is available to process one of the plurality of macroblocks.

11. The electronic device of claim 10, wherein the pre-processing thread is further configured to perform the video decoding and to selectively allocate one of the plurality of macroblocks to the pre-processing thread for the video decoding.

12. The electronic device of claim 11, wherein the pre-processing thread is configured to allocate the one of the plurality of macroblocks to the pre-processing thread for video decoding when none of the one or more processing threads is available to process the one of the plurality of macroblocks.

13. The electronic device of claim 2, wherein the pre-processing thread is configured to perform decoding of AC coefficients and DC coefficients of each of the plurality of macroblocks.

14. The electronic device of claim 2, wherein the firmware includes further instructions to configure one of the plurality of threads to operate as a front-end thread, wherein the front-end thread is configured to decode at least one of a frame header, a prediction mode, and a motion vector for each of the plurality of macroblocks.

15. The electronic device of claim 1, wherein the flash video data is decoded at a speed of 30 frames per second or more.

16. The electronic device of claim 1, wherein the flash video data is decoded at a resolution of up to 1280 by 720.

17. The electronic device of claim 1, wherein the flash video data includes one of:
a stored video file; and
streaming media.

18. The electronic device of claim 1, wherein the flash video data is compliant with a VP6 format.

19. The electronic device of claim 1, further comprising a device selected from the group consisting of a set top box, a music player, a video player, an entertainment unit, a navigation device, a communications device, a personal digital assistant (PDA), a fixed location data unit, and a computer, into which the multi-threaded processor and the memory are integrated.

20. An electronic device comprising:
a processor including a plurality of threads;
a memory that maintains firmware instructions executable by the processor to perform functions to process video data, wherein the instructions in the firmware configure at least some of the plurality of threads to operate as a plurality of dedicated function threads, including:
one or more processing threads, wherein each of the one or more processing threads is configured to perform video decoding on one or more macroblocks of video data;
a pre-processing thread configured to receive a plurality of macroblocks and to allocate at least some of the plurality of macroblocks among the one or more processing threads for video decoding.

21. The electronic device of claim 20, wherein the pre-processing thread allocates a particular macroblock of the plurality of macroblocks to a particular processing thread of the one or more processing threads via a task buffer from which the particular processing thread retrieves the particular macroblock without engaging an operating system.

22. The electronic device of claim 20, wherein the pre-processing thread is configured to at least partially balance a processing load of the one or more processing threads by selectively allocating the at least some of the plurality of macroblocks based on which of the one or more processing threads is available for allocation of one of the plurality of macroblocks.

23. The electronic device of claim 22, wherein when the pre-processing thread is further configured to perform video decoding and further configured, upon the pre-processing thread determining that none of the one or more processing threads is available for allocation of a next of the plurality of macroblocks, to allocate the next macroblock to the pre-processing thread for the pre-processing thread to perform the video decoding on the next macroblock.

24. The electronic device of claim 20, wherein the firmware includes further instructions that configure one of the plurality of threads to operate as a front-end thread, wherein the front-end thread is configured to decode at least one of a frame header, a prediction mode, and a motion vector for each of the plurality of macroblocks.

25. The electronic device of claim 20, wherein the firmware is further configured to cause another of the one or more processing threads to operate as a back-end thread, wherein the back-end thread is configured to perform at least one of deblocking and visual enhancement.

26. The electronic device of claim 20, wherein the video data is compliant with the VP6 format and the video data includes one of:
a stored video file; and
streaming media.

27. The electronic device of claim 20, wherein the memory and the processor are integrated in at least one semiconductor die.

28. The electronic device of claim 20, further comprising a device selected from the group consisting of a set top box, a music player, a video player, an entertainment unit, a navigation device, a communications device, a personal digital assistant (PDA), a fixed location data unit, and a computer, into which the memory and the processor are integrated.

29. A method comprising:
receiving video data including a plurality of macroblocks at a processor, the processor including a plurality of threads; and
configuring at least some of the plurality of threads according to instructions in firmware associated with the processor to perform dedicated functions, including:
configuring one or more of the plurality of threads as processing threads to perform video decoding on one or more macroblocks of the video data; and
configuring one of the plurality of threads as a pre-processing thread to allocate the plurality the macroblocks for the video decoding.

30. The method of claim 29, further comprising configuring the pre-processing thread to at least partially balance a load between the one or more processing threads by selectively allocating a particular macroblock of the plurality of macroblocks to a particular processing thread that is available to perform video decoding of the particular macroblock.

31. The method of claim 30, further comprising configuring the pre-processing thread to perform the video decoding and, when none of the one or more processing threads is available to perform video decoding of the particular macroblock, configuring the pre-processing thread to allocate the particular macroblock to the pre-processing thread for the video decoding.

32. The method of claim 29, further comprising allocating the plurality of macroblocks independently of an operating system.

33. The method of claim 32, further comprising allocating at least some of the plurality of macroblocks via a task buffer from which each of the one or more processing threads is configured to retrieve an allocated macroblock without locking the task buffer.

34. The method of claim 29, further comprising:
entering one of the one or more processing threads into a sleep state when none of the plurality of macroblocks has been allocated to the one of the one or more processing threads; and
awakening the one of the plurality of processing threads from the sleep state in response to at least one of the plurality of macroblocks being allocated to at least one of the one or more processing threads.

35. The method of claim 34, wherein the one of the one or more processing threads is awakened in response to detecting that a task flag is set for the one of the one or more processing threads.

36. The method of claim 34, wherein the one of the plurality of processing threads is awakened by the pre-processing thread presenting a wake up signal in response to the pre-processing thread allocating one of the plurality of macroblocks to the one of the one or more processing threads.

37. The method of claim 29, further comprising configuring one of the plurality of threads as a front-end thread, wherein the front-end thread is configured to decode at least one of a frame header, a prediction mode, and a motion vector for each of the plurality of macroblocks.

38. The method of claim 29, further comprising configuring one of the plurality of threads as a back-end thread, wherein the back-end thread is configured to perform at least one of deblocking and visual enhancement.
